(19) United States
(12) Patent Application Publication
(10) Pub. No.: US 2014/0145949 A1
(43) Pub. Date: May 29, 2014

(54) INSTRUCTION INPUT DEVICE AND METHOD USING EYE MOVEMENT

(71) Applicant: Hyundai Motor Company, Seoul (KR)

(72) Inventor: Sung Min Park, Seoul (KR)

(73) Assignee: HYUNDAI MOTOR COMPANY, Seoul (KR)

(21) Appl. No.: 13/897,791

(22) Filed: May 20, 2013

(30) Foreign Application Priority Data
Nov. 27, 2012 (KR) 10-2012-0135334

(51) Int. Cl. G06F 3/01

(52) U.S. Cl. CPC G06F 3/013
USPC 345/158

(57) ABSTRACT

An instruction input device and method using eye movement in which an error rate of detecting a point at which a user gazes, is reduced by storing frequencies of an object moving on a screen and instructions corresponding thereto. In addition, the error rate is reduced by comparing frequency detected from eye movement gazing at the object with the frequency of the object and determining as an input of an instruction when the compared value is included within a predetermined range.

### CROSS-REFERENCE TO RELATED APPLICATION

This application is based on and claims priority from Korean Patent Application No.10-2012-0135334, filed on Nov. 27, 2012 in the Korean Intellectual Property Office, the disclosure of which is incorporated herein in its entirety by reference.

### BACKGROUND OF THE INVENTION

1. Field of the Invention

The present invention relates to an instruction input apparatus and method using eye movement, and more particularly, to a technique that recognizes an input instruction based on a frequency detected from mechanical eye movement of a user.

2. Description of the Prior Art

Recently, various applications using eye tracking technologies have been developed and practiced. In addition, with the help of developments of various devices associated with sight, schemes for eye tracking are changing from tracking an eye two-dimensionally to three-dimensionally, and, accordingly, various three-dimensional eye tracking technologies are being developed.

The three-dimensional eye tracking technologies are also referred to as depth direction (perspective) eye tracking, since the tracking technologies recognize eye positions on a plane, such as a monitor, and also the distance of an object at which a user gazes from the eye, i.e., perspective, to represent the eye positions in a three-dimensional coordinate system rather than a two-dimensional coordinate system.

A method that controls various devices using such eye tracking technologies includes detecting a point (e.g., position) on a screen at which a user gazes and performing an operation corresponding to an instruction set to the point. However, the conventional method that controls devices is complex to implement, and, moreover, may not ensure the accuracy of the device control since eye tracking technologies have been found to be erroneous.

### SUMMARY

The present invention provides an instruction input device and method using eye movement in which an error rate of detecting a point at which a user gazes is reduced, by storing frequencies of an object moving on a screen and instructions corresponding thereto, comparing frequency detected from eye movement gazing at the object with the frequency of the object, and determining as an input of an instruction when the compared value is included within a predetermined range.

In one aspect of the present invention, an instruction input device using eye movement, may include a plurality of units executed by a control unit. The plurality of units may include: an information storage unit configured to store instructions each corresponding to a frequency of a corresponding object; a display unit configured to display objects such that each object moves at a corresponding frequency; an eye position detection unit configured to detect eye positions of a user for each time period; and a frequency detection unit configured to detect a frequency based on the eye positions of the user for each time period, detected by the eye position detection unit In addition, the control unit, may be configured to recognize an instruction corresponding to the frequency detected by the frequency detection unit, with reference to the instructions stored in the information storage unit.

In another aspect of the present invention, an instruction input method using eye movement, may include: storing, by a control unit, instructions each corresponding to a frequency of a corresponding object; displaying, by the control unit, objects to allow each object to move at a corresponding frequency; detecting, by the control unit, eye positions of a user for each time period; detecting, the control unit, a frequency based on the eye positions of the user for each time period; and recognizing, by the control unit, an instruction corresponding to the detected frequency, with reference to the stored instructions.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram illustrating an instruction input apparatus using eye movement according to an exemplary embodiment of the present invention;

FIG. 2A through 2C are exemplary views showing display manners by which an object has a certain frequency according to an exemplary embodiment of the present invention; and

FIG. 3 is an exemplary flowchart illustrating an instruction input method using eye movement according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings.

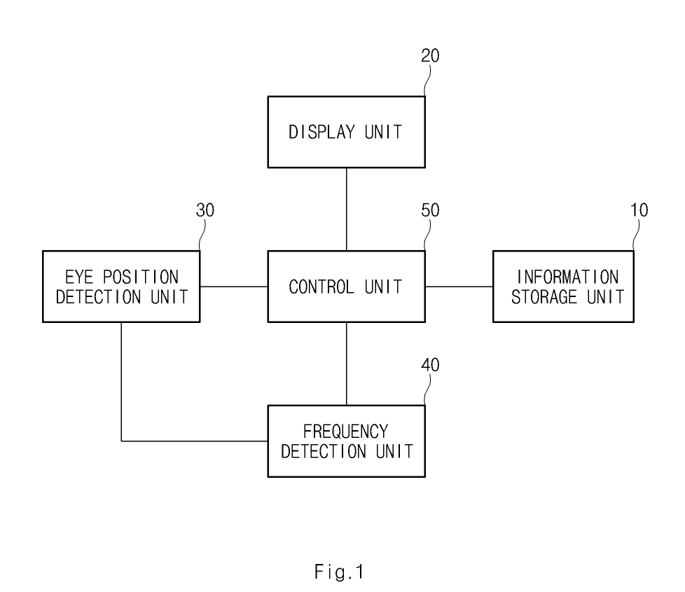

FIG. 1 is an exemplary diagram illustrating an instruction input apparatus using eye movement according to an exemplary embodiment of the present invention. As shown in FIG. 1, the instruction input apparatus using eye movement may include a plurality of units executed on a control unit 50. The plurality of units may include an information storage unit 10, a display unit 20, an eye position detection unit 30, and a frequency detection unit 40.

Specifically, the information storage unit 10 may be configured to store instructions each corresponding to a frequency of a corresponding object. Specifically, each object may be correlated with a preset frequency and each frequency may be correlated with an instruction. The display unit 20 may be configured to display that each object moves at a corresponding frequency. Additionally, the frequencies may range from 0.05 Hz to 5 Hz which may be derived from movement of an eye.

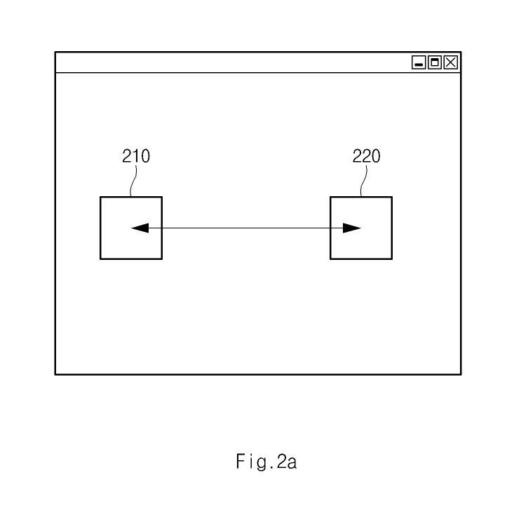

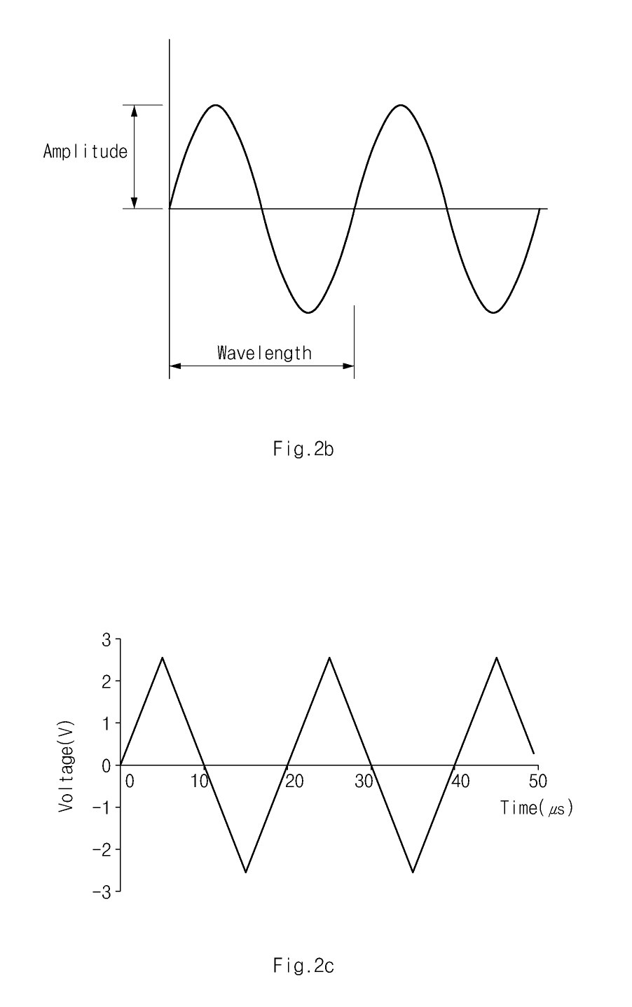

Generally, when a user (e.g., a driver) gazes at an object moving mechanically (e.g., periodically), an eye moves analogous to the object. Accordingly, once a frequency of an object is known, it may be possible to determine which object the user gazes at, by detecting eye movement and acquiring the frequency. In order for an object moving on a screen to have a particular frequency, the present invention uses the following three schemes shown in FIGS. 2A through 2C, respectively. In FIGS. 2A-2C, at least one object moves on the screen.

1) According to the scheme shown in FIG. 2A, an object 210 may appear at a first side and a second side 220 alternately and periodically. Accordingly, an eye of a user may alternately gaze at the object at the first side 210 and the second side 220 to detect a frequency.

2) According to the scheme shown in FIG. 2B, an object may move continuously on a screen in sine wave pattern.

3) According to the scheme shown in FIG. 2C, an object may move continuously on a screen in triangular wave pattern.

Then, the eye position detection unit 30 may be configured to detect an eye position of a user for each time period, i.e., eye movement of the user. Additionally, the eye position detection unit 30 may be configured to detect the eye position through an “Adaboost” algorithm.

In one embodiment, the eye position detection unit 30 may include a face region detector, a similarity calculator, and an eye position calculator. Initially, the face region detection unit may be configured to receive image data, detect face region from the image data and transmit a face image corresponding to the face region to the similarity calculator. Furthermore, the similarity calculator may be configured to calculate a similarity using the face image transmitted from the face region detector and an eye descriptor. In addition, the similarity calculator may be configured to calculate a pixel corresponding to an eye position based on the probability. Here, the eye descriptor may be stored in a database.

Subsequently, the eye position calculator may be configured to calculate a geometrical eye position at which the eye of the user is actual located (e.g.,, a three-dimensional coordinate of the pupil) using a position including a pixel corresponding to the eye position calculated in the similarity calculator. In other words, the eye position calculator may be configured to calculate a geometrical eye position using an angle of both pupils and a distance between both pupils. Further, the eye position calculator may be configured to output calculated eye position data relative to actual geometrical eye position.

Moreover, the frequency detection unit 40 may be configured to detect a frequency based on the eye positions of a user for each time period detected by the eye position detection unit 30. In other words, the frequency detection unit 40 may be configured to detect a peak value between 0.05 Hz and 5 Hz, excluding a direct current (DC) component, of an eye movement using an unequally spaced fast Fourier transform (FFT). The control unit 50 may be configured to operate the display unit 20 to allow an object moving on the screen to have a certain frequency. Further, the control unit 50 may be configured to execute the frequency detection unit 40 based on the eye positions of a user for each time period detected by the eye position detection unit 30. In addition, the control unit 50 may be configured to recognize an instruction corresponding to the frequency detected by the frequency detection unit 40 based on instructions stored in the information storage unit 50 according to the respective frequencies. In other words, the control unit 50 may be configured to detect a frequency of eye movement to determine an input instruction corresponding to the frequency.

The present invention may be applicable to devices which require input devices, and the instruction in the present invention may be easily input through frequency detection process according to eye movement.

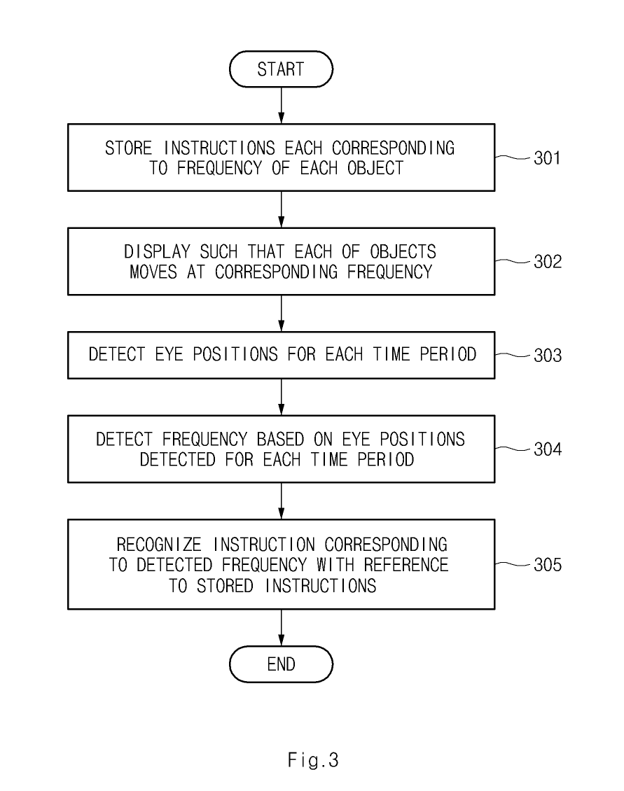

FIG. 3 is an exemplary flowchart illustrating an instruction input method using eye movement according to an embodiment of the present invention. The method may include: storing, by a control unit, instructions each corresponding to a frequency of a corresponding object (301) and displaying, by the control unit, that each object moves at the corresponding frequency (302). A user may gaze at the objects on a screen and an eye may move corresponding to the object movement. The method may further include detecting, by the control unit, the eye positions of the user for each time period (303); detecting, by the control unit, a frequency based on the eye positions of a user for each time period detected by the eye position detection unit 30 (304); and recognizing, by the control unit, an instruction corresponding to the detected frequency based on the instructions corresponding to the stored respective frequencies (305).

As stated above, the present invention provides an instruction input device and method using eye movement in which an error rate of detecting a point at which a user gazes may be reduced by storing frequencies of an object moving on a screen and instructions corresponding thereto, comparing frequency detected from eye movement gazing at the object with the frequency of the object, and determining as an input of an instruction when the compared value is included within a predetermined range.

What is claimed is:

1. An instruction input device using eye movement, comprising:
a control unit configured to:
store instructions each corresponding to a frequency of a corresponding object;
display objects on a display to show that each object moves at a corresponding frequency;
detect eye positions of a user for each time period;
detect a frequency based on the detected eye positions of the user for each time period; and
recognize an instruction corresponding to the detected frequency with reference to the stored instructions.

2. The instruction input device according to claim 1, wherein the control unit is further configured to:
operate the display to show that an object alternately appears on a first side and a second side of a screen.

3. The instruction input device according to claim 1, wherein the control unit is further configured to:
operate the display to show that an object moves on a screen in sine wave pattern.

4. The instruction input device according to claim 1, wherein the control unit is further configured to:
operate the display unit to show that an object moves on a screen in triangular wave pattern.

5. The instruction input device according to claim 1, wherein the control unit is further configured to:
operate the display to show that at least one object on a screen has a corresponding frequency.

6. An instruction input method using eye movement, comprising:
storing, by a control unit, instructions each corresponding to a frequency of a corresponding object;
displaying, by the control unit, objects on a display to show that each object moves at a corresponding frequency;
detecting, by the control unit, eye positions of a user for each time period;
detecting, by the control unit, a frequency based on the eye positions of the user for each time period; and
recognizing, by the control unit, an instruction corresponding to the detected frequency detected, with reference to the stored instructions.

7. The instruction input method according to claim 6, wherein the displaying includes:
displaying, by the control unit, an object to show that the object alternately appears on a first side and a second side of a screen.

8. The instruction input method according to claim 6, wherein the displaying includes:
displaying, by the control unit, an object to show that the object moves on a screen in sine wave pattern.

9. The instruction input method according to claim 6, wherein the displaying includes:
displaying, by the control unit, an object to show that the object moves on a screen in triangular wave pattern.

10. The instruction input method according to claim 6, wherein the displaying includes:
displaying, by the control unit, the objects to show that at least one object on a screen has a corresponding frequency.

11. A non-transitory computer readable medium containing program instructions executed by a processor or control unit, the computer readable medium comprising:
program instructions that store instructions each corresponding to a frequency of a corresponding object;
program instructions that display objects on a display to show that each object moves at a corresponding frequency;
program instructions that detect eye positions of a user for each time period;
program instructions that detect a frequency based on the eye positions of the user for each time period; and
program instructions that recognize an instruction corresponding to the detected frequency detected, with reference to the stored instructions.

12. The non-transitory computer readable medium of claim 11, further comprising:
program instructions that display an object to show that the object alternately appears on a first side and a second side of a screen.

13. The non-transitory computer readable medium of claim 11, further comprising:
program instructions that display an object to show that the object moves on a screen in sine wave pattern.

14. The non-transitory computer readable medium of claim 11, further comprising:
program instructions that display an object to show that the object moves on a screen in triangular wave pattern.

15. The non-transitory computer readable medium of claim 11, further comprising:
program instructions that display the objects to show that at least one object on a screen has a corresponding frequency.
